(19) United States
(12) Patent Application Publication
(10) Pub. No.: US 2026/0260530 A1
(43) Pub. Date: Sep. 3, 2026

(54) METHOD, SYSTEM AND COMPUTER PROGRAM PRODUCT FOR SECURING A PASSAGEWAY

(71) Applicant: DORMAKABA SCHWEIZ AG, Rümlang (CH)

(72) Inventor: Paul STUDERUS, Oberweningen (CH)

(21) Appl. No.: 18/846,898

(22) PCT Filed: Mar. 13, 2023
(86) PCT No.: PCT/EP2023/056308

§ 371 Date: Sep. 13, 2024

(30) Foreign Application Priority Data
Mar. 17, 2022 (CH) CH000285/2022

(51) Int. Cl. G07C 9/28; G07C 9/00; G07C 9/22

(52) U.S. Cl. CPC G07C 9/28; G07C 9/00309; G07C 9/22; G07C 2009/00793; G07C 2209/63

(57) ABSTRACT

A method for securing a passageway using a detection system, comprising the steps of: executing ultra-wideband transmissions with an UWB-enabled authentication device to determine its successive positions relative to a proximity area, an intent area and a virtual tap area; analyzing the successive positions of the UWB-enabled authentication device upon determining position of the UWB-enabled authentication device within the proximity area; performing an access control process with the UWB-enabled authentication device upon determining the position of the UWB-enabled authentication device within the intent area if an intent of passage is determined; and generating a first user indication of a virtual tap area and performing an access control process with the UWB-enabled authentication device upon determining the position of the UWB-enabled authentication device within the virtual tap area, if no intent of passage could be determined.

### TECHNICAL FIELD

The present disclosure relates to a method for securing a passageway using a detection system comprising one or more UWB detection device(s) associated with the passageway. The present disclosure further relates to a detection system for securing a passageway. The present disclosure even further relates to a computer program product comprising computer-executable instructions for causing a processing unit of a detection system to carry out a method for securing a passageway.

### TECHNICAL BACKGROUND

Keyless access control systems have become widely used for securing passageways, for example in building facilities, in particular for access control. Access control relates to granting, denying or limiting passage through a passageway, usually by means of some level of access control by use of a barrier, such as a door, turnstile, parking gate, elevator door, or other barrier.

Keyless access control systems operate in that a detection device executes a wireless communication with an authentication device, such as a keyless fob, a keycard or an authentication device incorporating a corresponding wireless transceiver. Once said wireless communication between the detection device and the authentication device has been executed, the detection device exchanges data messages with the authentication device. The authentication can be initiated either by a user, for instance by pressing a button on the authentication device to trigger transmission of authentication data to the detection device, or from the detection device itself which periodically transmits request signals and awaits a response message from the authentication device comprising authentication data. Upon successful authentication, i.e. verification of user credentials (e.g. by correlating authentication data received from the authentication device with a list of authorized users), the detection device grants access to the user in possession of the respective authentication device, e.g. by opening said barrier. On the other hand, if the authentication fails, the detection device denies access to the user in possession of the respective authentication device, e.g. by locking the barrier/by keeping the barrier locked.

For close-range applications, a radio-frequency identification (RFID) transponder (or tag) is often used, which has mostly replaced earlier magnetic stripe cards. Other current solutions use infra-red systems or radio systems to transmit an authenticating signal from an authentication device to a detection device of a security control system. Close-proximity keyless systems, (i.e. between direct contact and a threshold of a few centimeters), for example RFID based systems, allow determination of a user's proximity to a barrier by appropriate placement of a reader device of the detection device. However, as their name implies, close-proximity keyless systems suffer from the disadvantage that they require a very close proximity of the authentication device to the detection device which might prove inconvenient and/or time consuming for certain users.

In order to overcome this disadvantage, mid-range keyless access control systems have been proposed, in particular based on ultra-wideband UWB communication. Ultra-wideband UWB systems are advantageous since they allow reliable mid-range communication without a user having to precisely identify the reader device. As the communicating range between an authentication device and an UWB detection device increases, the convenience and ease-of-use increases, because the authentication device does not need to be placed in very close range, such as less than one centimeter from the UWB detection device. The user no longer needing to precisely locate the UWB detection device (or its antenna) not only adds convenience but also has the potential to speed up the process, thereby increasing the throughput through a barrier.

In addition to improving convenience and potentially speeding up the access control process, mid-range keyless access control systems based on ultra-wideband UWB communication provide a great flexibility for the placement of the UWB detection device. The capability of precisely determining the position of the authentication device removes the need to arrange the UWB detection device(s) directly at the respective passageway.

At the same time, as the authentication device no longer needs to be brought into close proximity of the UWB detection device, which might be anyhow positioned away from the passageway, measures need to be taken to ensure that access control is performed only when the authentication device is actually in the proximity of the passageway. According to a known method, this is achieved by associating a proximity area with the passageway and performing an access control process with an authentication device only once the authentication device is determined to be located within the proximity area.

In order to avoid accidentally performing an access control process with an authentication device which, while located within the proximity area, the user of which has no intention to actually initiate the access control process with the respective passageway (e.g. passes by a door without actually willing to open it), according to a known method, an intention of passage is detected before an access control process is initiated.

However, there are situations when an intent of passage cannot be (conclusively) detected using known mid-range keyless access control systems based on ultra-wideband UWB communication. This is in particular the case when, for security reasons, the tolerance/threshold for distinguishing between mere presence or passage and an intent of passage are set strictly. Known systems address this problem—the risk of not being able to always reliably detect an intent of passage—by requiring the authentication device to be brought into close proximity of the UWB detection device, sacrificing the above mentioned benefits of user convenience (not having to locate the reader) and flexibility in the placement of the UWB detection device. Alternatively, or additionally, known systems address this problem—the risk of not being able to always reliably detect an intent of passage—using redundant/auxiliary detection devices, such as a close-range redundant detection device (e.g. radio-frequency identification RFID) or even non-contactless authentication means (e.g. a backup keypad), adding costs and complexity to the system.

### SUMMARY

It is an object of embodiments disclosed herein to provide an improved method for securing a passageway which overcomes one or more of the disadvantages of prior art mid-range keyless solutions based on ultra-wideband UWB communication.

In particular, it is an object of embodiments disclosed herein to provide a method of securing a passageway using a keyless access control system, wherein situations when an intent of passage cannot be conclusively detected are addressed without increasing complexity and without sacrificing user convenience or positioning flexibility of the system's components.

According to the present disclosure, this object is addressed by the features of the independent claim 1. In addition, further advantageous embodiments follow from the dependent claims and the description.

In particular, this object is addressed by a method for securing a passageway, wherein a proximity area, an intent area and a virtual tap area may be associated with the passageway. The method may comprise the steps of: determining successive positions of an UWB-enabled authentication device (also referred to as UWB token), in particular relative to the proximity area, the intent area and the virtual tap area associated with the passageway; detecting an intent of passage through the passageway, whereby if an intent of passage is determined, an access control process is performed upon determining its position within the intent area; and if no intent of passage could be determined, a first user indication of a virtual tap area is generated and an access control process is performed upon determining the position of the UWB-enabled authentication device within the virtual tap area.

In a preparatory step, three distinct areas are associated with a passageway: a proximity area, an intent area and a virtual tap area.

The proximity area is an area defined on either one or all sides of a passageway (e.g. on either one or both sides of a door, a turnstile, a gateway) at the perimeter of which tracking of the UWB-enabled authentication device is triggered. The proximity area is defined large enough to facilitate determination of an intent of passage but small enough to reduce the number of tracked UWB-enabled authentication devices which do not manifest an intent of passage. Furthermore, according to embodiments, the proximity area is defined in view of respective range, sensitivity and/or reaction time of the UWB detection devices.

The intent area is an area is defined on either one or all sides of a passageway (e.g. on either one or both sides of a door, a turnstile, a gateway) delimiting the area within which an access control process with a UWB-enabled authentication device may be initiated. According to embodiments of the present disclosure, the intent area is arranged within the proximity area. An intent area smaller than the proximity area is advantageous in limiting the number of users, and hence UWB-enabled authentication devices within the intent area, thereby reducing the risk of tailgating. Tailgating refers to an unauthorized user being located close enough to an authorized user that the unauthorized user might erroneously gain access using the authorized user's credentials. Alternatively, if there is no need to strictly limit the number of users, the intent area coincides with the proximity area.

The virtual tap area associated with the passageway is an area which is provided as a backup in case no intent of passage could be conclusively determined. The virtual tap area is defined such that the presence of a UWB-enabled authentication device can be unquestionably associated with an intent of passage of the corresponding passageway. According to embodiments disclosed herein, the tap area is defined in the immediate vicinity of the passageway, such as within an arm's reach therefrom, so as to ensure that the UWB-enabled authentication device located within the virtual tap area is held by a person located at either side of the corresponding passageway. According to embodiments disclosed herein, the virtual tap area is arranged such as to prevent that an authentication device is accidentally located in the virtual tap area. As it will be described in following paragraphs, the virtual tap area may be hidden/invisible to a user and indicated only on a need-to basis.

After the preparatory steps of defining the proximity, intent and virtual tap areas, ultra-wideband transmissions are executed with an UWB-enabled authentication device using one or more ultra-wideband transceiver(s) of the UWB detection device(s) to determine successive positions of the UWB-enabled authentication device. The successive positions of the UWB-enabled authentication device may in particular be determined relative to the proximity area, the intent area and the virtual tap area. The term “relative to” may be understood as equivalent to the term “with respect to” and/or the term “within”. According to embodiments disclosed herein, the successive positions of the UWB-enabled authentication device are first determined in a two- or three-dimensional space by triangulation, the positions within the two- or three-dimensional space being then converted into data indicative of the relative positions with respect to the proximity area, the intent area and the virtual tap area, such as a binary value indicative whether the UWB-enabled authentication device is or is not located within the respective area. The successive positions of the UWB-enabled authentication device are determined by processing signal properties of the one or more ultra-wideband transmissions.

The UWB detection device is configured to determine the position(s) of the UWB-enabled authentication device by processing signal properties of the ultra-wideband UWB transmissions such as propagation time, amplitude difference and/or phase difference of the ultra-wideband transmissions. Determining the position(s) of the UWB-enabled authentication device by processing signal properties of the ultra-wideband UWB transmissions is advantageous since it allows a reliable and precise localization.

Determining the position of the UWB-enabled authentication device based on the propagation time of an ultra-wideband transmission comprises measuring the time required for a signal to travel from the ultra-wideband transceiver to an ultra-wideband communication module of the UWB-enabled authentication device and/or the time required for a signal to travel from the UWB-enabled authentication device to the ultra-wideband transceiver. In a particular embodiment, a time difference is used as a basis for determining the distance, as it is more secure against spoofing attacks, wherein a third party may use a radio relay device to gain unauthorized access to a position or system in a so-called “relay-attack”. Depending on the embodiment, the time difference is a “one-way time-of-flight” time difference between the ultra-wideband transceiver sending the request value and the UWB-enabled authentication device receiving the request value, or a “round-trip time-of-flight” time difference, in which a second transmission takes place from the UWB-enabled authentication device to the ultra-wideband transceiver either prior to, or after the first transmission of the request value. In the “one-way time-of-flight” scenario, the ultra-wide-band transceiver and the UWB-enabled authentication device need to be provided with tightly synchronized clocks for accurately determining the position. In the latter case of a “round-trip time-of-flight” calculation, there is stored, either in the UWB-enabled authentication device or the ultra-wideband transceiver, an accurate representation of the processing time, i.e. the time it takes between the reception of an ultra-wideband transmission and the sending of a response ultra-wideband transmission, which processing time allows for accurately determining the distance. Measurement of a time required for the signal to travel from the ultra-wideband transceiver to the UWB-enabled authentication device and back “round-trip time-of-flight” is advantageous as it does not require the precise synchronization of clock signals of the ultra-wideband transceiver and the UWB-enabled authentication device.

Determining the position of the UWB-enabled authentication device based on amplitude difference comprises determining the difference in signal amplitude between the signal transmitted by the ultra-wideband transceiver and the signal received by the UWB-enabled authentication device (or vice-versa). By taking into consideration the attenuation of the signal, the distance between the ultra-wideband transceiver and the UWB-enabled authentication device is calculated.

Determining the position of the UWB-enabled authentication device based on phase difference comprises detecting the difference in signal phase between the signal transmitted by the ultra-wideband transceiver and the signal received by the UWB-enabled authentication device. By taking into consideration the change in signal phase, the distance between the ultra-wideband transceiver and the UWB-enabled authentication device is determined. It is to be understood that for the amplitude difference and phase difference, alternatively, the signal may also be transmitted by the UWB-enabled authentication device and received by the ultra-wideband transceiver.

According to embodiments of the present disclosure, determining the position(s) of the UWB-enabled authentication device is based on UWB-ranging, comprising determining a distance between the UWB detection device(s) and the UWB-enabled authentication device and an angle of arrival of the respective UWB signals.

Once the UWB-enabled authentication device has been detected within the proximity area, the successive positions of the UWB-enabled authentication device are analyzed by the UWB detection device(s).

The successive positions of the UWB-enabled authentication device are analyzed by the UWB detection device(s) to determine an intent of passage. In particular, the successive positions of the UWB-enabled authentication device are compared with a set of behavioral pattern(s) indicative of an intent of passage. The set of behavioral pattern(s) are stored in a datastore comprised by or communicatively connected to the detection system.

According to embodiments, a movement trajectory of the UWB-enabled authentication device is determined by based on its successive positions. The movement trajectory of the UWB-enabled authentication device is then compared to behavioral pattern(s) comprising movement trajectory patterns indicative of an intent of passage, such as an “approaching” trajectory of movement within the proximity area oriented (essentially) towards the passageway. Optionally, the temporal distribution/speed of an “approaching” movement trajectory is also compared to a temporal distribution/speed of behavioral pattern(s). For example, a fast approaching user (carrying a UWB-enabled authentication device) is distinguished from a slowly approaching user, who is assumed not to intend to pass through the passageway but merely walking by, “wandering around”. Alternatively, or additionally, the amount of time spent within the proximity area is also assessed when analyzing the successive positions of the UWB-enabled authentication device, an extended period of time spent within the proximity area being an indication of an intent of passage.

According to embodiments disclosed herein, several indicators are combined (e.g. in a weighted function) to calculate a probability of an intent, an intent of passage being concluded if the probability exceeds a threshold value.

Depending on whether an intent of passage has been determined, an access control process with the UWB-enabled authentication device is performed according to the UWB-enabled authentication device's location within the intent area or the tap area. If an intent of passage is determined, an access control process is performed with the UWB-enabled authentication device upon determining the position of the UWB-enabled authentication device within the intent area.

According to embodiments wherein the proximity area and the intent area coincide, the access control process is triggered immediately after detecting the intent of passage. Alternatively, according to embodiments wherein the proximity area and the intent area do not coincide, the access control process is initiated only when the user (carrying a UWB-enabled authentication device) enters the intent area. For example, a user is recognized to be walking straight towards a door (based on analyzing the successive positions of the UWB-enabled authentication device carried by the user) with a clear intent to open the door already when the user is relatively far away from the door. The intent of passage being determined the detection system keeps analyzing the successive positions of the user, and only initiates the access control process once the user is in the immediate vicinity of the door, i.e. within the intent area, in order to prevent unauthorized persons to open the door just because a different user (carrying an authorized UWB-enabled authentication device) is within the proximity area. Hence, convenience and security may be optimally balanced based on use case.

If no intent of passage could be determined (based on analyzing the successive positions of the UWB-enabled authentication device), a first user indication of a virtual tap area is generated.

According to embodiments, the successive positions of the UWB-enabled authentication device within the proximity area are analyzed after the UWB-enabled authentication device entered the proximity area. After exceeding an intent detection timeout, the alternative method of triggering the access control process (placement of the UWB-enabled authentication device in the tap area) is initiated by generation of the first user indication of the virtual tap area. The first user indication is generated to guide the user to place the UWB-enabled authentication device within the virtual tap area. According to embodiments, the first user indication is a visual, an audible and/or haptic indication of the virtual tap area, for example an illuminated area, a beeping sound from an area and/or vibrating surface adjacent to the passageway.

The successive positions of the UWB-enabled authentication device are further analyzed, and, upon determining the position of the UWB-enabled authentication device within the virtual tap area, the access control process is performed with the UWB-enabled authentication device. Hence, placing the UWB-enabled authentication device acts as a substitute/backup solution to determining an intent of passage based on the comparison of successive positions of the UWB-enabled authentication device with a set of behavioral pattern(s).

Due to the significantly smaller size of the tap area, the determination of the location of the UWB-enabled authentication device within the tap area is significantly less affected by disturbances—such as the presence of several UWB-enabled authentication devices in the proximity area—as compared to the determination of an intent of passage based on comparison of successive positions of the UWB-enabled authentication device with a set of behavioral pattern(s).

The method for securing a passageway according to the present disclosure is advantageous as it has the potential to optimally balance convenience and security. In a default scenario, an intent of passage is detected and the user is provided with a highly convenient passage, the user not being required to take any manual action to trigger the access control process, such as holding the UWB-enabled authentication device at a specific location. At the same time, in the presence of any ambiguity, i.e. without a conclusive determination of an intent of passage, an alternative way of triggering the access control process is required. While increasing security and avoiding unsuccessful attempts, this alternative way of triggering the access control process is only marginally less convenient to the user, holding the UWB-enabled authentication device to the virtual tap area closely resembling authentication using a close-proximity keyless systems such as RFID based authentication.

According to embodiments disclosed herein, the access control process performed by the detection system with a UWB-enabled authentication device comprises:
authenticating a user associated with the UWB-enabled authentication device by exchanging authentication data using the ultra-wideband transmission(s) between the UWB-enabled authentication device and the ultra-wideband transceiver(s) of the UWB detection device(s);
determining whether the user is authorized passage through the passageway;
if the user is authorized, granting passage through the passageway; and
if the user is not authorized, denying passage through the passageway.

Authentication data, as used herein, comprises—but is not limited to—a user ID, a user name, a government- or institution-issued identification number and/or identity verification data such as a secure ID, a personal identification number PIN, an access key, and/or a password. According to embodiments, the authentication data further comprises access control data—in particular encrypted access control data—such as data indicative of a user's authorization of passage through the passageway. Additionally, the access control data may comprise access data indicative of one or more access condition(s), such as an access authorization time window, prohibited or mandatory presence of further persons within the proximity or intent area.

According to embodiments disclosed herein, the authentication data is transmitted by the UWB-enabled authentication device to the detection system in an encrypted format to prevent unauthorized access (eavesdropping) of said authentication data. In a subsequent step, the detection system receives authentication data from the UWB-enabled authentication device. Alternatively, or additionally, the authentication data is confirmed by biometric data, such as a fingerprint, retinal scan and/or voice pattern.

According to embodiments disclosed herein, the authentication data is transmitted from the UWB-enabled authentication device to the detection system in the same ultra-wideband frequency as the messages used for determining its location. Alternatively, or additionally the authentication data is transmitted from the UWB-enabled authentication device to the detection system using a wireless communication module of the UWB-enabled authentication device and a corresponding wireless communication module of the detection system, using an alternative communication technology (as compared to UWB) such as a Bluetooth (BT), Bluetooth Low Energy (BLE), a Wireless Local Area Network (WLAN), ZigBee, Radio Frequency Identification (RFID), Z-Wave, and/or Near Field Communication (NFC). Having received the authentication data, the authentication data is verified in order to determine whether the authenticated user is authorized passage through the passageway. Such verification of the authentication data may be performed either by a comparison with authentication data stored in a datastore (comprised by or communicatively connected to the access control device) and/or by verification using a corresponding algorithm.

According to embodiments, granting/denying passage through the passageway comprises controlling an access control barrier(s) and/or a door-lock such as to allow, respectively prevent passage through the passageway.

It is an object of further embodiments to facilitate securing passageways for a so-called asymmetrical use. An asymmetrical use refers to cases when different processes are to be applied in dependence of a direction of passage of the passageway. In other words, the access control process is to be initiated differently depending on a user entering or exiting through the passageway. This further object is addressed in that a so-called no-intent area is associated with the passageway. In particular, the no-intent area is defined at a side of the passageway opposite to the intent area. The successive positions of the UWB-enabled authentication device are determined further relative to the no-intent area and the access control process is performed with the UWB detection device upon determining the position of the UWB-enabled authentication device within the no-intent area regardless of an intent of passage having been determined. Such an asymmetrical use is advantageous in areas where an entry side of the passageway is frequented also by people other than those who intend to pass through the passageway—such as a hallway, whereby the opposite side of the passageway is approached only by people who do intend to exit through the passageway. Hence, the intent of passage can be implicitly assumed and the authentication process initiated in the no-intent area. It is to be understood, that the term “opposite” refers to a direction of passage and not necessarily a geometrically opposite side.

In order to improve the efficiency of the method/detection system for securing a passageway and to enhance user friendliness, a second user indication is generated upon determining the UWB-enabled authentication device within the proximity area. The second user indication is provided to inform a user that the UWB-enabled authentication device of the user has been detected by the detection system. Indicating detection removes potential user uncertainty, hence the user is more likely to move towards the passageway in a more decisive manner. Therefore, in addition to improving user friendliness, the efficiency of the method/detection system is improved in that the successive positions of the UWB-enabled authentication device have a “cleaner” trajectory and therefore are more likely to match the behavioral pattern(s) indicating intent of passage with a higher probability. The second user indication may be described as an “I see you” signal to the user.

Additionally, or alternatively, a third user indication is generated upon determining an intent of passage. The third user indication is provided to inform a user associated with the UWB-enabled authentication device that the intent of passage has been detected by the detection system. The third user indication encourages the user to keep approaching the passageway. As a result, the efficiency of the method/detection system is improved in that the access control process may be more timely initiated. Furthermore, the efficiency of the method/detection system is improved in that the number of times a user stops approaching or even recedes (due to uncertainty) is reduced, thereby reducing the amount of unnecessarily tracking UWB-enabled authentication devices.

Additionally, or alternatively, a fourth user indication is generated upon triggering of the access control process with the UWB-enabled authentication device. The fourth user indication is provided to inform a user associated with the UWB-enabled authentication device of a status of the access control process. The fourth user indication removes uncertainty and hence encourages the user to remain stationary (in the intent area). As a result, the efficiency of the method/detection system is improved by reducing the number of times the access control process is interrupted by the user leaving the intent area due to uncertainty of the status of the access control process. For example, the fourth user indication may be implemented as a traffic-light-style indicator, indicating a successful, an ongoing and a failed access control process by green, amber respectively red colored visual indications. Alternatively, or additionally, the fourth user indication may be implemented as a progress bar on a display device arranged in the vicinity of the passageway.

According to embodiments disclosed herein, generating the first user indication, the second user indication, the third user indication; and/or the fourth user indication comprises generating data for controlling indicator device(s) to provide a visual, an audible and/or haptic indication of the virtual tap area, the UWB-enabled authentication device having been detected by the detection system, the intent of passage having been detected by the detection system or a status of the the access control process, respectively.

In order to remove any enticement for a user to make the supplementary effort of bringing the UWB-enabled authentication device in the tap area—which would remove the seamless experience provided by mid-range keyless access control systems based on ultra-wideband UWB communication—the first user indication is only shown if a user has been detected within the proximity area and no intent of passage has been detected. If no user (no UWB-enabled authentication device) is within the proximity area for a certain amount of time or if an intent of passage is detected, the first user indication of the virtual tap area is disabled. In addition to improving user friendliness, the efficiency of the method/detection system is improved in that unnecessary detections of UWB-enabled authentication devices within the tap area, and unnecessary activation of the indicator device, are avoided.

In order to increase security, according to embodiments, any detected intent of passage through the passageway is disregarded upon determining two or more UWB-enabled authentication devices within the intent area and/or within the proximity area. In order to eliminate the risk of performing the access control process with the wrong UWB-enabled authentication device, the access control process is performed with the UWB-enabled authentication device upon determining the position of the UWB-enabled authentication device within the virtual tap area. Thereby the potential ambiguity—introduced by the presence of two or more UWB-enabled authentication devices within the intent area and/or within the proximity area—is addressed without sacrificing user convenience or positioning flexibility of the system's components and without the need for supplementary authentication means.

The guidance provided to the user—by the first, second, third and/or fourth user indication—improves the continued human-machine interaction, greatly reducing the number of failed, interrupted or intermittent attempts of the access control process.

It shall be understood that in the context of the present disclosure, the wording “upon” is used to describe a moment in time simultaneous or following an event, synonymous to the wording “as soon as”, “following” or “after”. In other words, the event following the wording “upon” can be described as a trigger for an action.

It shall be further understood that the term “particular” as used in the present specification refers to embodiments of the disclosure, without any indication of preference or indication that features introduced as particular would be preferred or essential to any of embodiments.

It is an object of embodiments disclosed herein to provide an improved detection system for securing a passageway which overcomes one or more of the disadvantages of prior art mid-range keyless solutions based on ultra-wideband UWB communication.

According to the present disclosure, this object is addressed by the features of the independent claim 15. In addition, further advantageous embodiments follow from the dependent claims and the description.

In particular, this object is addressed by a detection system comprising one or more UWB detection device(s), each detection device(s) comprising one or more ultra-wideband transceiver(s) configured for executing ultra-wideband transmissions with an UWB-enabled authentication device, wherein the detection system is configured to carry out the method for securing a passageway according to any of the embodiments disclosed herein.

It is an object of embodiments disclosed herein to provide a computer program product for securing a passageway which overcomes one or more of the disadvantages of prior art mid-range keyless solutions based on ultra-wideband UWB communication.

According to the present disclosure, this object is addressed by the features of the independent claim 16. In addition, further advantageous embodiments follow from the dependent claims and the description.

In particular, this object is addressed a computer program product comprising computer-executable instructions which, when executed by a processing unit of a detection system causes the detection system to carry out the method for securing a passageway according to any of the embodiments disclosed herein.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings in which:

FIG. 1: shows a flowchart of a first embodiment of the method for securing a passageway according to the present disclosure;

FIG. 2: shows a flowchart of a further embodiment of the method for securing a passageway according to the present disclosure;

FIG. 3: shows a highly schematic perspective view of a first embodiment of a detection system for securing a passageway according to the present disclosure, illustrating a proximity area, an intent area and a virtual tap area associated with the passageway;

FIG. 4: shows a highly schematic perspective view of the detection system for securing a passageway of FIG. 3, wherein a user is located in an intent area associated with the passageway;

FIG. 5: shows a highly schematic perspective view of the detection system for securing a passageway of FIGS. 3 and 4, wherein multiple users are located within the proximity area associated with the passageway;

FIG. 6: shows a highly schematic perspective view of a further embodiment of a detection 5 system for securing a passageway according to the present disclosure, a no-intent area being further associated with the passageway;

FIG. 7: shows a highly schematic block diagram of a UWB detection system according to the present disclosure;

FIG. 8A: shows a highly schematic block diagram of a first embodiment of a UWB-enabled authentication device according to the present disclosure comprised by a smartphone; and

FIG. 8B: shows a highly schematic block diagram of a further embodiment of a UWB-enabled authentication device according to the present disclosure comprised by a tag (such as a key tag or badge).

### DETAILED DESCRIPTION OF EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

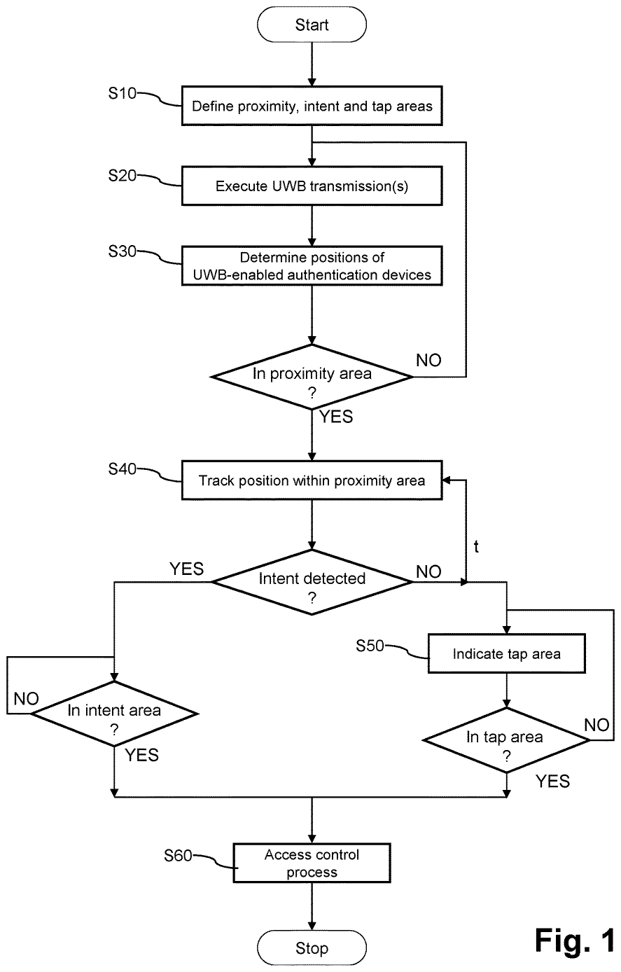

FIG. 1 shows a flowchart of a first embodiment of the method for securing a passageway 5 according to the present disclosure. In a preparatory step S10, three distinct areas are associated with a passageway: a proximity area P, an intent area I and a virtual tap area T. The proximity area P is an area defined on either one or all sides of a passageway (e.g. on either one or both sides of a door, a turnstile, a gateway) at the perimeter of which tracking of the UWB-enabled authentication device 100 is triggered. The intent area I is an area defined on either one or all sides of a passageway (e.g. on either one or both sides of a door, a turnstile, a gateway) delimiting the area within which an access control process with a UWB-enabled authentication device 100 may be initiated. The virtual tap area T associated with the passageway 5 is an area which is provided as a backup in case no intent of passage could be conclusively determined. The virtual tap area T is defined such that the presence of a UWB-enabled authentication device 100 can be unquestionably associated with an intent of passage of the corresponding passageway 5. According to embodiments disclosed herein, the virtual tap area T is defined in the immediate vicinity of the passageway 5, such as within an arm's reach therefrom, so as to ensure that the UWB-enabled authentication device 100 located within the virtual tap area T is held by a person located at either side of the corresponding passageway 5. According to embodiments disclosed herein, the virtual tap area T is arranged such as to prevent that an authentication device is accidentally located in the virtual tap area T. As it will be described in following paragraphs, the virtual tap area T may be hidden/invisible to a user and indicated only on a need-to basis.

After the preparatory step, in a step S20, ultra-wideband transmissions are executed with an UWB-enabled authentication device 100 using one or more ultra-wideband transceiver(s) 12 of the UWB detection device 10 to determine successive positions of the UWB-enabled authentication device 100. In a step S30, the successive positions of the UWB-enabled authentication device 100 are determined relative to the proximity area P, the intent area I and the virtual tap area T. The successive positions of the UWB-enabled authentication device 100 are first determined in a two- or three-dimensional space by triangulation, the positions within the two- or three-dimensional space are then converted into data indicative of the relative positions with respect to the proximity area P, the intent area I and the virtual tap area T, such as a binary value indicative whether the UWB-enabled authentication device is or is not located within the respective area. The successive positions of the UWB-enabled authentication device 100 are determined by processing signal properties of the one or more ultra-wideband transmissions.

Once the UWB-enabled authentication device 100 has been detected within the proximity area P, in a step S40, the successive positions of the UWB-enabled authentication device 100 are analyzed by the UWB detection device(s) 10. In other words, the position of the UWB-enabled authentication device 100 is tracked within the proximity area P.

First, the successive positions of the UWB-enabled authentication device 100 are analyzed by the UWB detection device(s) to determine an intent of passage by comparison with a set of behavioral pattern(s) indicative of an intent of passage. The set of behavioral pattern(s) are stored in a datastore 20 comprised by or communicatively connected to the UWB detection device 10.

The successive positions of the UWB-enabled authentication device 100 within the proximity area P are analyzed for a period of time from the moment the UWB-enabled authentication device 100 entered the proximity area P. If an intent of passage is determined, the successive positions of the UWB-enabled authentication device 100 within the proximity area P are further analyzed to determine whether the user, carrying the UWB-enabled authentication device 100, enters the intent area I. The access control process—in step S60—is initiated upon determining the position of the UWB-enabled authentication device 100 within the intent area I.

If, after lapse of an intent detection timeout t—after the UWB-enabled authentication device 100 has been detected to enter the proximity area P—without an intent being identified, the alternative method of triggering the access control process (placement of the UWB-enabled authentication device 100 in the virtual tap area T) is initiated by generation, in a step S50, of the first user indication of the virtual tap area T. The first user indication is generated as an illuminated rectangle adjacent to the passageway 5 to guide the user to place the UWB-enabled authentication device 100 within the virtual tap area T.

As described above, depending on whether an intent of passage has been determined, an access control process with the UWB-enabled authentication device 100 is performed—in step S60—according to the UWB-enabled authentication device's 100 location within the intent area I or the virtual tap area T, namely upon its detection in the intent area I if an intent has been detected, respectively upon its detection in the virtual tap area T in case of the absence of a detected intent. In a first step of (an) access control process(es), authentication data is received from the UWB-enabled authentication device 100. Having received the authentication data, the authentication data is verified in order to determine whether the authenticated user is authorized passage through the passageway 5. Such verification of the authentication data may be performed either by a comparison with authentication data stored in a datastore 20 (comprised by or communicatively connected to the access control device) and/or by verification using a corresponding algorithm. If, based on verifying the authentication data, it has been determined that the authenticated occupant is authorized, passage is granted to the user associated with the respective UWB-enabled authentication device 100, e.g. by disengaging a locking mechanism. On the other hand, if, based on verifying the authentication data, it has been determined that the authenticated occupant is not authorized, passage is denied to the user associated with the respective UWB-enabled authentication device 100. Granting/denying passage is carried out in particular using barrier(s), such as doors, turnstiles or the like.

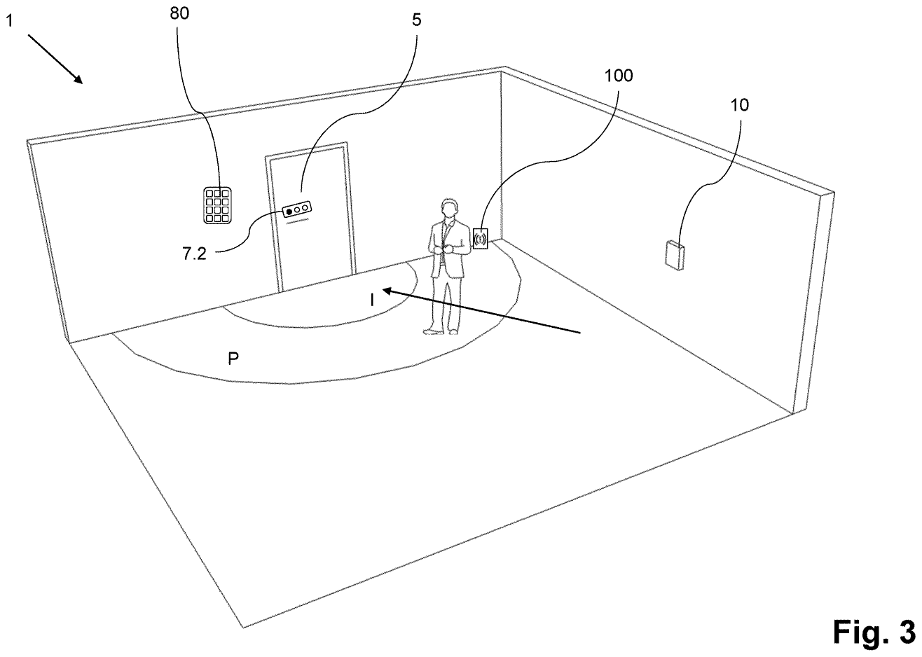

Optionally, authentication of occupants not carrying and hence not associated with a UWB-enabled authentication device 100 is performed using an alternative authentication device 80, illustrated on FIGS. 3 to 5 with a keypad for entering a PIN.

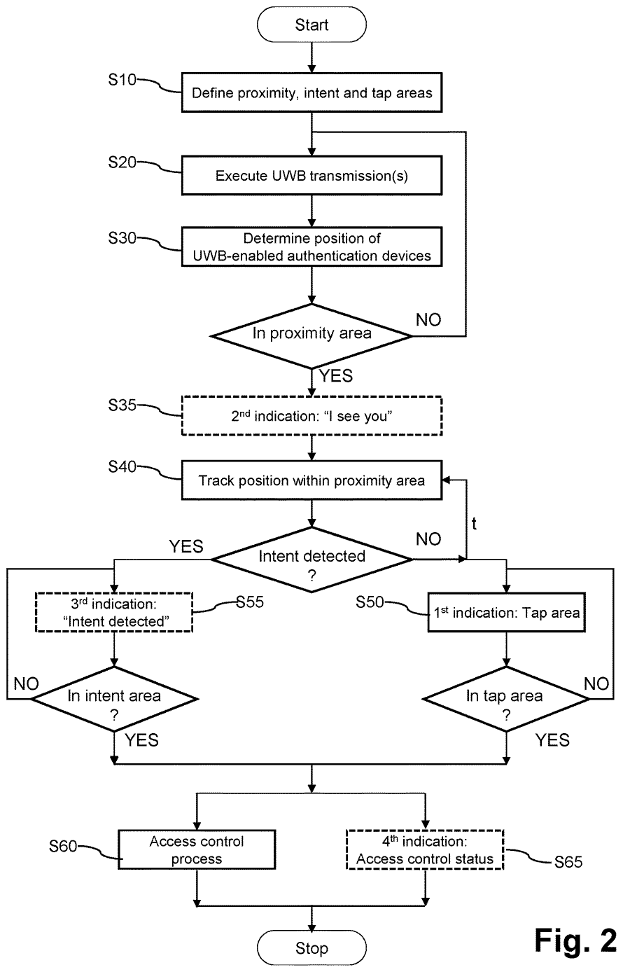

Turning now to FIG. 2, a further embodiment of the method for securing a passageway 5 shall be described. As illustrated, in a step S35, a second user indication is generated as soon as the UWB-enabled authentication device 100 is detected within the proximity area P. The second user indication is provided to inform a user that the UWB-enabled authentication device 100 of the user has been detected by the detection system 1. Indicating detection removes potential user uncertainty, hence the user is more likely to move towards the passageway in a more decisive manner. The second user indication may be described as an “I see you” signal to the user.

Furthermore, as soon as an intent of passage has been detected, in a step S55, a third user indication is provided to inform the user associated with the UWB-enabled authentication device 100 that the intent of passage has been detected by the detection system 1. The purpose of the third user indication is to encourage the user to keep approaching the passageway 5 and enter the intent area I.

Additionally, in a step S65, a fourth user indication is generated upon triggering of the access control process with the UWB-enabled authentication device 100. The fourth user indication is provided to inform a user associated with the UWB-enabled authentication device 100 of a status of the access control process. The fourth user indication removes uncertainty and hence encourages the user to remain stationary in the intent area I for the duration of the access control process.

Turning now to FIGS. 3 to 6, particular embodiments of the detection system 1 for securing a passageway 5 shall be described.

FIGS. 3 to 6 show highly schematic perspective views of a first embodiment of a detection system 1 for securing a passageway 5, a door being arranged in the passageway 5, lockable such as to enable access control though the passageway 5. As shown, a proximity area P is defined on an outer side of a door at the perimeter of which tracking of the UWB-enabled authentication device 100 is triggered. As exemplified on the figures, the proximity area P may be a half-cylinder delimited centered around the door, e.g. having a radius of 20, 10, 5 meters or less.

Furthermore, an intent area I is defined on the same, outer side of the passageway 5, delimiting the area within which an access control process with a UWB-enabled authentication device 100 may be initiated. As exemplified on the figures, the intent area I is a half-cylinder concentric with the proximity area P, e.g. having a radius of 20, 10, 5 meters or less.

As shown in FIGS. 3 to 6, the UWB detection device 10 does not need to be arranged within the proximity area P, the intent area I, or the virtual tap area T. The UWB detection device 10 is arranged such as to be able to determine the location of UWB-enabled authentication devices 100 relative to the proximity, intent and virtual tap areas P, I, T. Hence, it is sufficient to arrange the UWB detection device 10 such that the furthest point of any of the proximity, intent and virtual tap areas P, I, T is still within the range of the one or more ultra-wideband transceiver(s) 12 of the UWB detection device 10. The flexibility of placement of the UWB detection device 10 is particularly advantageous if more than one passageway is to be secured with a single UWB detection device 10.

A further indicator device 7.2, in the form of a traffic-light-style indicator is provided on the door, configured to provide any one of the second, third or fourth indications, to inform a user that that he/she has been detected, informing about an intent of passage being detected, respectively indicating a successful, an ongoing and a failed access control process by green, amber respectively red colored visual indications.

Also shown on FIGS. 3 to 6 is a keypad 80 provided as an alternative authentication device for the authentication of occupants not carrying and hence not associated with a UWB-enabled authentication device 100.

The arrow of FIG. 3 illustrates the movement trajectory of a user carrying a UWB-enabled authentication device 100, the user just having entered the proximity area P. Hence, the virtual tap area T is not shown on FIG. 3, to illustrate that the virtual tap area T is not indicated to a user just entering the proximity area P—the virtual tap area T only being shown if no intent of passage is determined for an intent detection timeout t from the moment the UWB-enabled authentication device 100 entered the proximity area P.

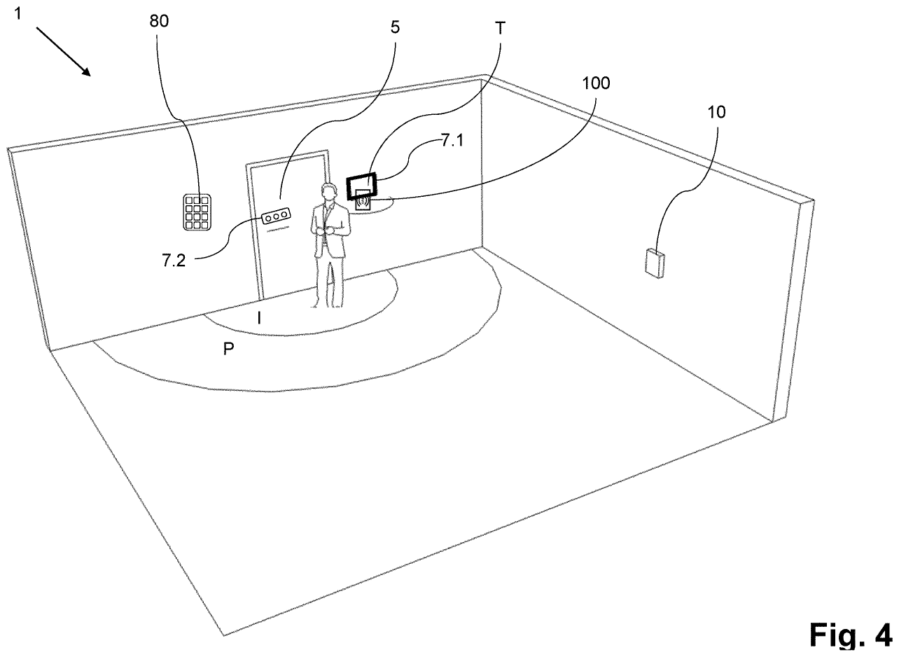

FIG. 4 shows a highly schematic perspective view of the detection system 1 for securing a passageway 5, depicting a situation when the user is located in the intent area I but no intent of passage could be determined. FIG. 4 shows the user placing the UWB-enabled authentication device 100 in the virtual tap area T, thereby triggering the alternative/back-up method of initiating the access control process. An indicator device 7.1 is provided as an illuminated rectangle adjacent to the passageway 5 to show the location of the virtual tap area T. The illumination of the indicator device 7.1 indicating the virtual tap area T is only turned on when a UWB-enabled authentication device 100 is detected within the proximity area P and no intent of passage has been detected for a period equal to or longer than an intent detection timeout t. The illumination of the indicator device 7.1 indicating the virtual tap area T is turned off if no user (no UWB-enabled authentication device 100) is within the proximity area P or if an intent of passage is detected.

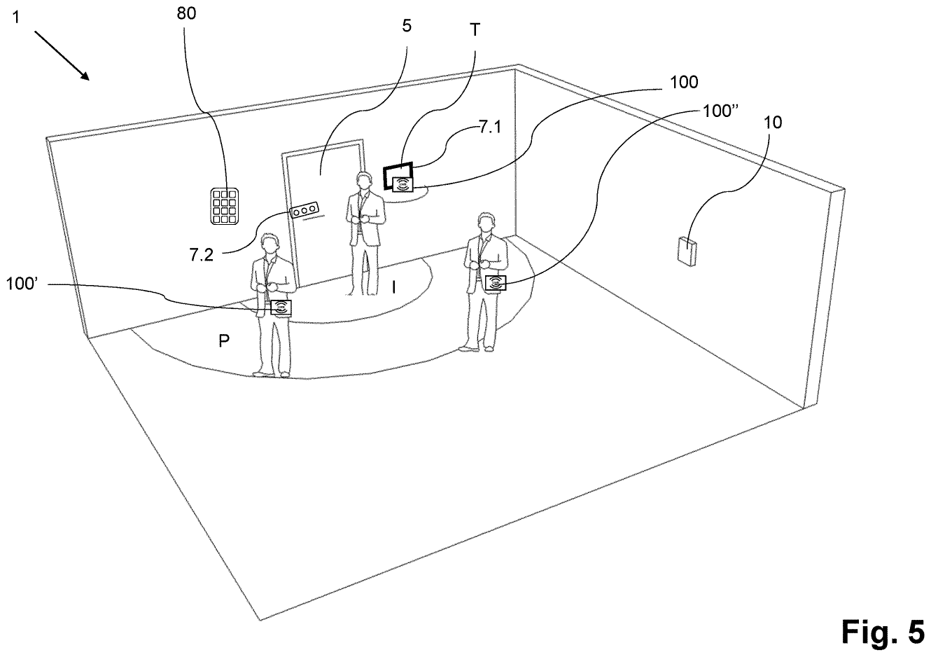

FIG. 5 shows a highly schematic perspective view of the detection system 1 for securing a passageway 5 of FIGS. 3 and 4, wherein multiple users each carrying a UWB-enabled authentication device 100, 100′, 100″ are located within the proximity area P associated with the passageway 5. Therefore, in order to increase security, any detected intent of passage is disregarded to eliminate the potential ambiguity—introduced by the presence of two or more UWB-enabled authentication devices 100, 100′, 100″. Instead of initiating the access control process by way of an intent of passage, the users are directed—by the first user indication shown by the indicator device 7.1—to place the UWB-enabled authentication device 100 into the virtual tap area T to initiate the access control process.

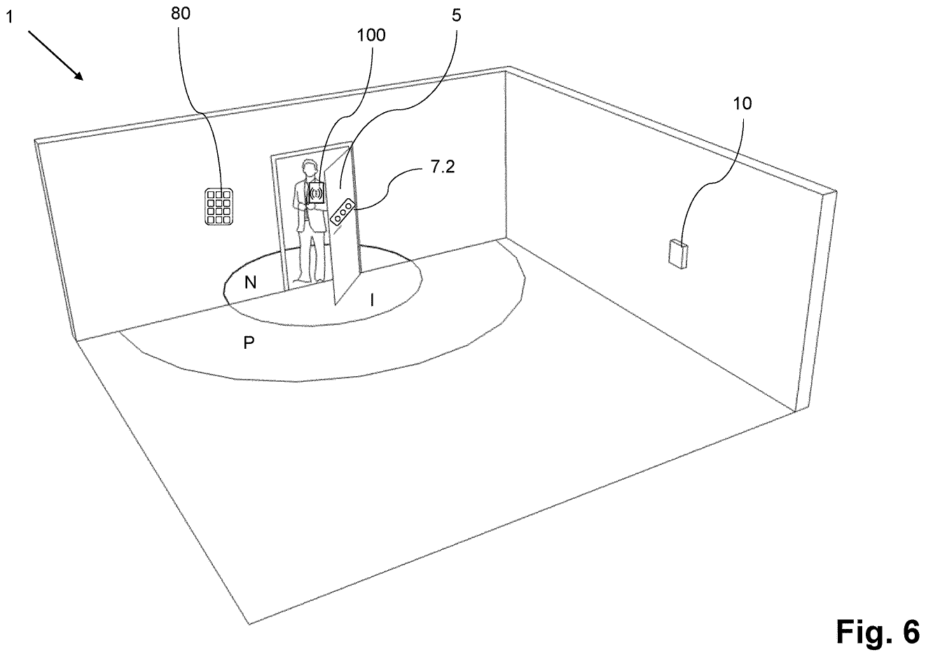

FIG. 6 shows a highly schematic perspective view of a further embodiment of a detection system 1 for securing a passageway 5, wherein a no-intent area N is further associated with the passageway 5. The no-intent area N is defined at an inside of the passageway 5 opposite to the intent area I and the detection system 1 is configured to initiate the access control process immediately upon detecting a UWB-enabled authentication device 100 within the no-intent area N, regardless of an intent of passage being detectable or not—based on the assumption that anyone approaching from the inside of the passageway 5 does intend to exit the passageway 5.

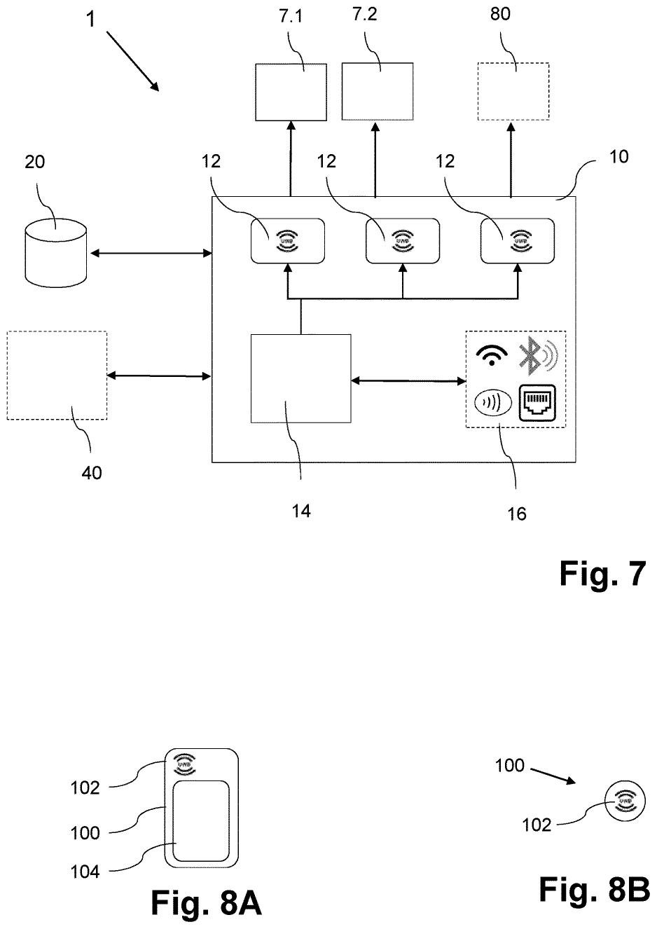

FIG. 7 shows a highly schematic block diagram of a UWB detection system 1 according to the present disclosure. As shown, the UWB detection device 10 comprises a processing unit 14 and one or more ultra-wideband transceiver(s) 12. The one or more ultra-wideband transceiver(s) 12 are configured to execute ultra-wideband transmissions with an authentication device 100 in order to determine its location by processing signal properties of the ultra-wideband UWB transmissions such as propagation time, amplitude difference and/or phase difference of the ultra-wideband transmissions. Overall, the UWB detection system 1 is configured for carrying out the method for securing a passageway 5 according to one of the embodiments disclosed herein. Furthermore, the UWB detection system 1 comprises a datastore 20 (comprised by or communicatively connected to the UWB detection device 10) for the storage of set of behavioral patterns and/or authentication data). An indicator device 7.1 is communicatively connected to the UWB detection device 10, configured to indicate the location of the virtual tap area T. A further indicator device 7.2, e.g. in the form of a traffic-light-style indicator, is communicatively connected to the UWB detection device 10, configured to provide any one of the second, third or fourth indications, to inform a user that that he/she has been detected, informing about an intent of passage being detected, respectively indicating a successful, an ongoing and a failed access control process by green, amber respectively red colored visual indications. Alternatively, the indicator device 7.1 or the further indicator device 7.2 is configured to provide an audible and/or haptic indication of the virtual tap area T, for example an illuminated area, a beeping sound from an area and/or vibrating surface adjacent to the passageway 5. Optionally, for the authentication of occupants not carrying and hence not associated with a UWB-enabled authentication device 100, an alternative authentication device 80, such as a keypad, magnetic card, RFID reader, or biometric reader is communicatively connected to the UWB detection device 10.

According to further embodiments of the present disclosure (shown with dashed lines on FIG. 7), the UWB detection device 10 further comprises a communication module 16 for establishing data communication link(s) with other UWB detection devices 10 and/or barrier(s) and/or with a processing unit 40 of the detection system 1 external to any one of the UWB detection devices 10. According to embodiments of the present disclosure, the communication module 16 comprises wireless communication interface(s) (such as Bluetooth Low Energy BLE, a Wireless Local Area Network WLAN, ZigBee, Radio Frequency Identification RFID, Z-Wave, and/or Near Field Communication NFC interface(s)) and/or wired communication interface(s) (such as an Ethernet interface).

FIG. 8A shows a highly schematic block diagram of a first embodiment of an authentication device 100 according to the present disclosure comprised by a smartphone, the authentication device 100 comprising a display screen 104 for displaying (among other information) the visual representations of the flow control data. Furthermore, the authentication devices 100 comprise an ultra-wideband communication module 102. The ultra-wideband communication module 102 is configured for establishing an ultra-wideband transmission with the respective ultra-wideband transceiver(s) 12 of the UWB detection device(s) 10 of the security control system 1.

FIG. 8B shows a highly schematic block diagram of a further embodiment of an authentication device 100 according to the present disclosure comprised by a tag (such as a key tag or badge). LIST OF REFERENCE NUMERALS
detection system 1
passageway 5
indicator device 7.1, 7.2
UWB detection device 10
ultra-wideband transceiver (of UWB detection device) 12
processing unit (of UWB detection device) 14
communication module (of UWB detection device) 16
datastore (of detection system) 20
processing unit (of detection system) 40
alternative authentication device 80
UWB-enabled authentication device 100
ultra-wideband communication module (of the authentication device) 102
display (of authentication device) 104
intent detection timeout t

1. A method for securing a passageway using a detection system comprising one or more UWB detection device(s) associated with the passageway, a proximity area, an intent area and a virtual tap area being associated with the passageway, the method comprising the steps:
executing ultra-wideband transmissions with an UWB-enabled authentication device using one or more ultra-wideband transceiver(s) of the UWB detection device(s) to determine successive positions of the UWB-enabled authentication device by processing signal properties of the one or more ultra-wideband transmissions;
analyzing the successive positions of the UWB-enabled authentication device upon determining of the UWB-enabled authentication device within the proximity area;
performing an access control process with the UWB-enabled authentication device upon determining the position of the UWB-enabled authentication device within the intent area if an intent of passage is determined—based on analyzing the successive positions of the UWB-enabled authentication device; and
generating a first user indication of a virtual tap area associated with the passageway and performing an access control process with the UWB-enabled authentication device upon determining the position of the UWB-enabled authentication device within the virtual tap area, if no intent of passage could be determined—based on analyzing the successive positions of the UWB-enabled authentication device.

2. The method according to claim 1, wherein detecting an intent of passage through the passageway comprises comparing the successive positions of the UWB-enabled authentication device with a set of behavioral pattern(s) indicative of an intent of passage.

3. The method according to claim 1, wherein detecting an intent of passage through the passageway comprises detecting a reduction of the distance between the successive positions of the UWB-enabled authentication device and the passageway.

4. The method according to claim 1, further comprising:
determining the successive positions of the UWB-enabled authentication device further relative to a no-intent area;
performing an access control process with the UWB-enabled authentication device upon determining the position of the UWB-enabled authentication device within the no-intent area regardless of an intent of passage having been determined.

5. The method according to claim 4, wherein the no-intent area and the intent area are arranged on opposite sides of the passageway.

6. The method according to claim 1, further comprising generating a second user indication upon determining the UWB-enabled authentication device within the proximity area, the second user indication enabling informing a user associated with the UWB-enabled authentication device that the UWB-enabled authentication device has been detected by the detection system.

7. The method according to claim 1, further comprising generating a third user indication upon determining an intent of passage, the third user indication enabling informing a user associated with the UWB-enabled authentication device that the intent of passage has been detected by the detection system.

8. The method according to claim 1, further comprising generating a fourth user indication upon triggering of the access control process with the UWB-enabled authentication device, the fourth user indication enabling informing a user associated with the UWB-enabled authentication device of a status of the access control process.

9. The method according to claim 1, wherein generating:
the first user indication;
the second user indication;
the third user indication; and/or
the fourth user indication
comprises generating data for controlling indicator device(s) to provide a visual, an audible and/or haptic indication of:
the virtual tap area;
the UWB-enabled authentication device having been detected by the detection system;
the intent of passage having been detected by the detection system; and/or
a status of the access control process,
respectively.

10. The method according to claim 9, further comprising controlling the indicator device(s) to disable the visual, audible and/or haptic indication of the virtual tap area if an intent of passage is determined or no UWB-enabled authentication device is determined within the proximity area.

11. The method according to claim 1, wherein performing an access control process with the UWB-enabled authentication device comprises:
authenticating a user associated with the UWB-enabled authentication device by exchanging authentication data using the ultra-wideband transmission(s) between the UWB-enabled authentication device and the ultra-wideband transceiver(s) of the UWB detection device(s);
determining whether the user is authorized passage through the passageway;
if the user is authorized, granting passage through the passageway; and
if the user is not authorized, denying passage through the passageway.

12. The method according to claim 11, wherein granting or denying passage through the passageway comprises controlling an access control barrier(s) and/or a door-lock such as to allow, respectively prevent passage through the passageway.

13. The method according to claim 1, further comprising disregarding any detected intent of passage through the passageway upon determining two or more UWB-enabled authentication devices within the intent area and/or within the proximity area and performing the access control process with the UWB-enabled authentication device upon determining the position of the UWB-enabled authentication device within the virtual tap area.

14. The method according to claim 1, wherein the processing of the signal properties comprises processing one or more of: a propagation time, an amplitude variation, or a phase difference of signals of the one or more ultra-wideband transmission(s).

15. A detection system for securing a passageway, comprising one or more UWB detection device(s), each detection device(s) comprising one or more ultra-wideband transceiver(s) configured for executing ultra-wideband transmissions with an UWB-enabled authentication device, wherein the detection system is configured to carry out the method comprising the steps:
executing ultra-wideband transmissions with an UWB-enabled authentication device using one or more ultra-wideband transceiver(s) of the UWB detection device(s) to determine successive positions of the UWB-enabled authentication device by processing signal properties of the one or more ultra-wideband transmissions;
analyzing the successive positions of the UWB-enabled authentication device upon determining of the UWB-enabled authentication device within the proximity area;
performing an access control process with the UWB-enabled authentication device upon determining the position of the UWB-enabled authentication device within the intent area if an intent of passage is determined based on analyzing the successive positions of the UWB-enabled authentication device; and
generating a first user indication of a virtual tap area associated with the passageway and performing an access control process with the UWB-enabled authentication device upon determining the position of the UWB-enabled authentication device within the virtual tap area, if no intent of passage could be determined—based on analyzing the successive positions of the UWB-enabled authentication device.

16. A computer program product comprising computer-executable instructions which, when executed by a processing unit of a detection system, in particular a detection system, causes the detection system to carry out the method comprising the steps:
executing ultra-wideband transmissions with an UWB-enabled authentication device using one or more ultra-wideband transceiver(s) of the UWB detection device(s) to determine successive positions of the UWB-enabled authentication device by processing signal properties of the one or more ultra-wideband transmissions;
analyzing the successive positions of the UWB-enabled authentication device upon determining of the UWB-enabled authentication device within the proximity area;
performing an access control process with the UWB-enabled authentication device upon determining the position of the UWB-enabled authentication device within the intent area if an intent of passage is determined based on analyzing the successive positions of the UWB-enabled authentication device; and
generating a first user indication of a virtual tap area associated with the passageway and performing an access control process with the UWB-enabled authentication device upon determining the position of the UWB-enabled authentication device within the virtual tap area, if no intent of passage could be determined—based on analyzing the successive positions of the UWB-enabled authentication device.
